(19) United States
(12) Patent Application Publication
(10) Pub. No.: US 2009/0078745 A1
(43) Pub. Date: Mar. 26, 2009

(54) Method for forming interconnects

(76) Inventors: Ee Hua Wong, Singapore (SG); Simon Kah Seah, Singapore (SG)

Correspondence Address: DICKSTEIN SHAPIRO LLP, 1825 EYE STREET NW, Washington, DC, 20006-5403, US

(21) Appl. No.: 11/902,888

(22) Filed: Sep. 26, 2007

(51) Int. Cl. B23K 31/02; B23K 1/20

(52) U.S. Cl. 228/173.1; 228/180.22

(57) ABSTRACT

A method for forming interconnects between a component and a substrate. The method comprises determining at least one location of differential flexing between a component and a substrate during drop impact; and forming a plurality of solder joints on at least one of the component and the substrate. A first number of the plurality of solder joints has a reduced amount of solder and a second number of the plurality of solder joints has normal solder content. The method also comprises conducting solder reflow of the plurality of solder joints to form interconnects between the component and the substrate. Those interconnects formed by the first number of solder joints have a reduced amount of solder forming an included angle with at least one of the component and the substrate. The included angle is large compared to an included angle between each of: the component and the substrate, and the second number of solder joints of normal solder content.

### TECHNICAL FIELD

This invention relates to a method for forming interconnects and more particularly, though not exclusively, to a method for fabricating elongated solder joints.

### BACKGROUND

In microelectronic packaging, integrated circuit (IC) components or individual packages (in wafer-level packaging) are mounted using solder joints onto printed circuit boards (PCBs). Among other factors, the reliability of the solder joints between the components or packages and the PCB is dependent on their resistance to sudden impact, particularly in products susceptible to drop impact or sudden, strong forces. For example, PCBs with IC components in mobile/cellular telephones subjected to impact forces when dropped; electronic equipment in aircraft subjected to violent turbulence; and electronic equipment in automobiles when traveling over rough terrain. Under such situations (hereinafter collectively termed “drop impact”), the solder joints experience high strain rates.

Drop impact also results in flexing of a PCB assembly. Differential flexing between the PCB and the IC component induces severe deformation of their interconnecting solder joints as the IC component and the PCB flex or bend especially at locations of higher flexibility. The differential rate of flexing/bending, and the resultant curvature, creates high stresses in barrel-shaped solder ball joints, particularly bending, axial and shear stresses. Flexing, or differential flexing, is the main mechanism causing solder joint stress.

During high strain-rate loading, there is suppression of plastic deformation, leading to higher stresses in the solder joints. This tends to cause brittle fracture of the joints. Brittle fracture is exacerbated at the regions of stress concentration, particularly at the edges of the joints. Stress concentrations can arise due to the geometrical form of the joint. Typically, stresses concentrate at the edge where a traditional barrel-shaped solder ball connects with the component/package or the PCB. The stress concentration is due to the small radius of the included angle between the barrel-shaped solder ball and the PCB.

The often-used solution to the problem of brittle or stress fractures in barrel-shaped solder ball joints at locations of high flexibility has been to increase the amount of solder in the ball joint. This has not solved the problem.

### SUMMARY

According to a first aspect, there is provided a method for forming interconnects between a component and a substrate. The method may comprise determining at least one location of differential flexing between a component and a substrate during drop impact, and forming a plurality of solder joints on at least one of the component and the substrate. A first number of the plurality of solder joints may have a reduced amount of solder and a second number of the plurality of solder joints may-have normal solder content. The method may also include conducting solder reflow of the plurality of solder joints to form interconnects between the component and the substrate; those interconnects formed by the first number of solder joints having a reduced amount of solder forming an included angle with at least one of the component and the substrate; the included angle being large compared to an included angle between each of: the component and the substrate, and the second number of solder joints of normal solder content.

The first number of solder joints with the reduced amount of solder may form interconnects that are substantially hour-glass in shape. The reduction in the amount of solder may be in the range 10 to 50%. The included angle for the interconnects formed from the first number of solder joints with the reduced amount of solder may be in the range 90° to 155°, preferably 110° to 130°.

The distance between the component and the substrate may be determined and maintained by the second number of solder joints with normal solder content interconnecting the component and the substrate.

The second number of solder joints with normal solder content may retain a barrel shape after solder reflow.

The first number of solder joints with reduced solder content and the second number of solder joints with normal solder content may be partially flattened by a die press prior to connection with the substrate.

The method may further comprise mechanically upsetting the component during solder reflow.

The first number of solder joints having a reduced amount of solder may be formed from small solder balls having less solder volume than the second number of normal solder balls, or by printing less solder paste on selected substrate pads. The printed solder paste may be reflowed together with normal solder balls.

### BRIEF DESCRIPTION OF THE DRAWINGS

In order that the invention may be fully understood and readily put into practical effect there shall now be described by way of non-limitative example only preferred embodiments of the present invention, the description being with reference to the accompanying illustrative drawings.

In the drawings:

FIG. 1 is a schematic representation of an exemplary embodiment of solder balls on a component surface prior to die pressing;

FIG. 2 is a schematic representation of the exemplary embodiment of FIG. 1 during die pressing;

FIG. 3 is a schematic representation of exemplary embodiment of FIG. 1 after die pressing;

FIG. 4 is a schematic representation of the exemplary embodiment of FIG. 1 after component placement and prior to solder reflow;

FIG. 5 is a schematic representation of the exemplary embodiment of FIG. 1 after solder reflow;

FIG. 6 is a schematic representation of an exemplary embodiment of solder bumps on a substrate surface;

FIG. 7 is a schematic representation of the exemplary embodiment of FIG. 6 after component placement and prior to solder reflow;

FIG. 8 is a schematic representation of the exemplary embodiment of FIG. 6 after solder reflow;

FIG. 9 is a flowchart of an exemplary embodiment of the method;

FIG. 10 is a flowchart of another exemplary embodiment of the method; and

FIG. 11 is an illustrative exemplary embodiment of a printed circuit board with solder balls.

### DETAILED DESCRIPTION OF EXEMPLARY EMBODIMENTS

According to one aspect, there is provided an exemplary embodiment of a method for fabricating elongated solder joints for improved drop impact reliability.

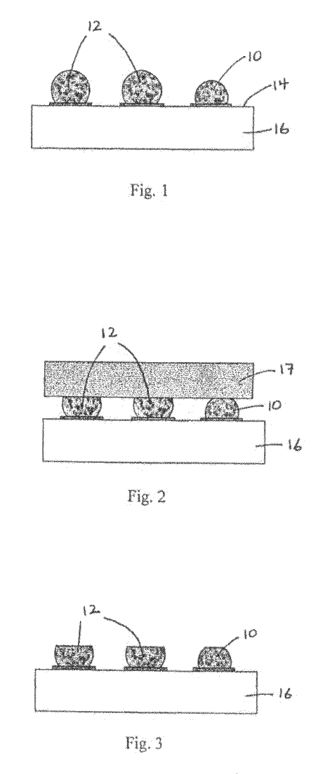

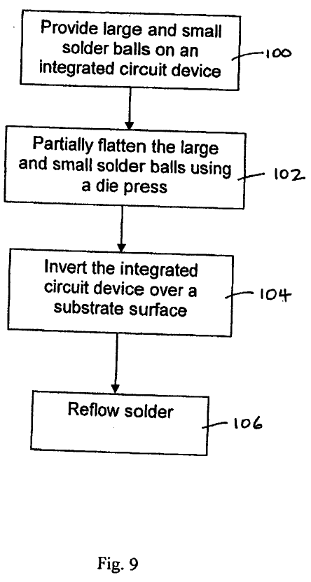

Referring to FIG. 1, solder ball 10 is on a surface 14 of a component 16 or packages such as IC component, and is at a location of higher differential flexing of the PCB 20 to which the component 16 is to be mounted. The solder ball 10 has a reduced content of solder compared to a “normally-sized” solder ball. The reduction in the amount of solder may be in the range 10% to 50%. At locations of lower differential flexing, normal-sized solder balls 12 are provided on the surface 14 of the component 16 (100, FIG. 9).

The smaller solder ball 10 and normal solder balls 12 are partially flattened using a die press 17 (102, FIG. 9) as shown in FIGS. 2 and 3. The IC component 16 is then mechanically upset by inverting over a substrate surface 18 of the PCB 20 (104, FIG. 9). Solder reflow is allowed to take place between the IC component 16 and the PCB 20 (106, FIG. 9).

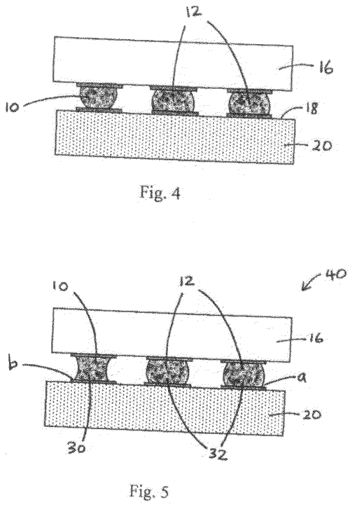

FIG. 4 shows small solder ball 10 and normal solder balls 12 inverted over the substrate surface 18. Normal solder balls 12 determine and maintain the distance between the IC component 16 and the PCB 20 during reflow. During reflow, the larger normal solder balls 12, being more numerous than the small solder ball 10, cause the IC component 16 to rise. However, as shown in FIG. 5, small solder ball 10, having a reduced amount of solder, is forced to elongate while it maintains contact with the pads on surface 14 and surface 18 due to surface tension. This results in the formation of a PCB assembly 40 having elongated interconnect 30 as well as conventional interconnects 32 between the IC component 16 and the PCB 20.

As can be seen in FIG. 5, the included angle a between a normal solder ball 12 (now interconnect 32) and the substrate surface 18 is a relatively small angle—about 30° as shown. The larger the solder ball 12/interconnects 32, the smaller the angle a, and the greater the problem. The small angle a concentrates stresses at the apex of angle a. This will tend to induce brittle fractures in normal solder ball 12 at or adjacent to the apex of angle a—at its joint with the substrate surface 18. For the small solder ball 10, the included angle b between the resultant elongated interconnect 30 and the substrate surface 18 is a relatively large angle—about 120° as shown. The relatively large angle b tends to dissipate impact-induced stresses through the elongated interconnect 30 and thus reduces the tendency to form brittle fractures at or adjacent to the joint of the elongated interconnect 30 and the substrate surface 18. The same situation will apply at the component surface 14.

Therefore, by having elongated interconnects 30 formed from small solder balls 10 at locations of high differential flexing, the likelihood of brittle fracture at the joint of the elongated interconnects 30 and the substrate surface 18 and/or the component surface 14, is reduced. Also, the elongated shape of the joint means the joint is more compliant, resulting in a further reduction of stresses.

The included angle a is normally less than 45° whereas the included angle b is preferably in the range 90° to 155°, more preferably 110° to 130°.

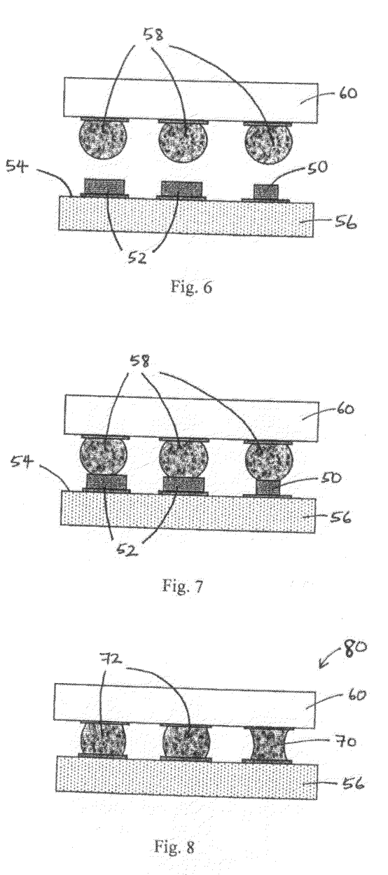

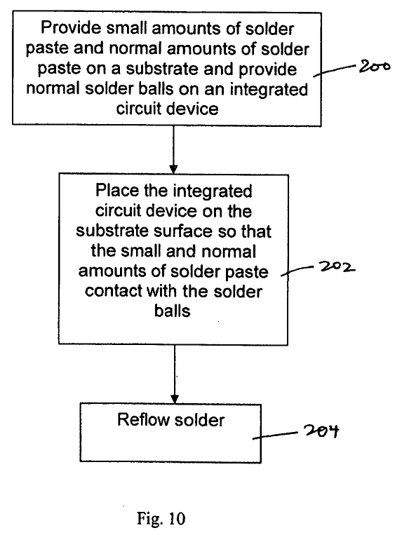

According to a second aspect, there is provided another exemplary embodiment of the method for fabricating elongated solder joints. Referring to FIGS. 6 to 8, an elongated solder joint 70 is formed by printing a small amount of solder paste 50 on a selected substrate pad compared to the normal amount of solder paste 52 for forming normal joints 72. This can be achieved, for example, by having a stencil opening of a smaller diameter than the opening used for printing normal sized solder paste. Normal solder balls 58 are provided on an IC component 60 (200, FIG. 10).

The IC component 60 is then placed on the PCB 56 such that the solder paste 50, 52 comes into contact with the normal solder balls 58 as shown in FIG. 7 (202, FIG. 10). Solder reflow then takes place (204, FIG. 10). Elongation of the solder joint at the small amount of solder paste 50 occurs during reflow, as shown in FIG. 8, because the reduced volume of solder provided by the small amount of solder paste 50 and its corresponding solder ball 58 has to span the distance between the IC component 60 and the PCB 56 that is determined and maintained by the normal amount of solder paste 52 and their corresponding solder balls 58

After solder reflow, the small amount of solder paste 50 and its corresponding solder ball 50 form an elongated interconnect 70 that is generally hour-glass in shape. The normal amount of solder paste 52 and their corresponding normal solder balls 58 form normal barrel-shaped interconnects 72. This results in a PCB assembly 80 having interconnects 70, 72 formed between the IC component 60 and the PCB 56.

As with the first exemplary embodiment, the normal interconnects 72 have a small included angle a while the smaller, elongated interconnect 70 has a large included angle b. As such, compared to the barrel-shaped interconnects 72, elongated interconnects 70 have a larger radius where they join with either the IC component or the PCB. The larger radius results in a lower stress concentration than the smaller radius of the barrel-shaped interconnects 72. Consequently, drop impact reliability of the solder joint using elongated interconnects 70 is greatly enhanced. Elongated interconnects also experience significantly lower stresses during flexing of the PCB assembly 80 as the thinner, neck portion of the hour-glass shape has greater flexibility and thus the ability to absorb the bending, shear and axial stresses induced due to differential flexing. Preferably, elongated interconnects 70 are used at locations of a PCB assembly that experience the greatest flexing.

Smaller solder balls/paste 10, 50 typically have a reduced solder volume equivalent to a ball diameter ranging from 0.3 to 0.35 mm, whereas normal solder balls/paste 12, 52 typically have an equivalent diameter of about 0.4 mm.

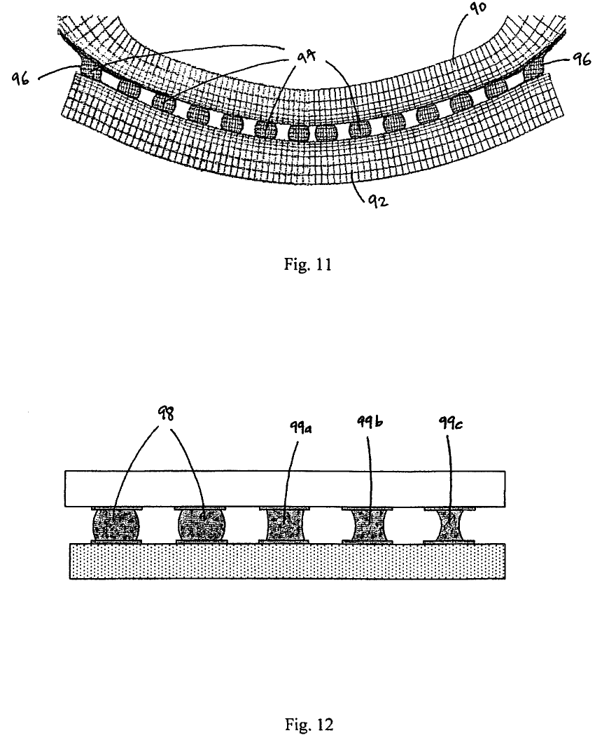

In FIG. 11 there is shown a computer simulation of bending of a PCB 90 connected to an IC component 92 by solder joints 94. Because the PCB 90 bends more than the IC component 92 under the same load, and at different locations, the first number of solder balls 94 on the IC component 92 at the periphery 96 of the IC component 92 should be the small solder joints 30/70 described above so as to minimize brittle fracture at these joints where differential flexing is higher. Where differential flexing is lower, the solder balls may be the normal solder balls. There may be a second number of normal solder balls. The first number and the second number may be different, or the same.

Locations of higher flexing during drop impact may be determined by one or more of: experiment, experience, or computer modeling. Besides designing for elongated interconnects at locations of higher flexing, a graduated range of interconnects may be provided at areas of increasing flexing, for example, from normal bumps 98 to increasingly elongated solder joints 99a, 99b, 99c respectively, as shown in FIG. 12.

Whilst there has been described in the foregoing description exemplary embodiments of the present invention, it will be understood by those skilled in the technology concerned that many variations in details of design, construction and/or operation may be made without departing from the present invention. While stencil-printing has been described to provide small solder bumps, other commonly known solder methods such as dispensing and screen printing may be used. Also, although the method has been described to interconnect an IC component and a PCB, the method may also be used to fabricate elongated interconnects for wafer-level packaging, for interconnecting wafer-to-wafer, among other forms of microelectronics packaging.

What is claimed is:

1. A method for forming interconnects between a component and a substrate, the method comprising:
determining at least one location of differential flexing between a component and a substrate during drop impact;
forming a plurality of solder joints on at least one of the component and the substrate, a first number of the plurality of solder joints having a reduced amount of solder and a second number of the plurality of solder joints having normal solder content;
conducting solder reflow of the plurality of solder joints to form interconnects between the component and the substrate;
those interconnects formed by the first number of solder joints having a reduced amount of solder forming an included angle with at least one of the component and the substrate;
the included angle being large compared to an included angle between each of:
the component and the substrate, and the second number of solder joints of normal solder content.

2. A method as claimed in claim 1, wherein the first number of solder joints with the reduced amount of solder form interconnects that are substantially hour-glass in shape.

3. A method as claimed in claim 1, wherein the reduction in the amount of solder is in the range 10 to 50%.

4. A method as claimed in claim 1, wherein the included angle for the interconnects formed from the first number of solder joints with the reduced amount of solder is in the range 90° to 155°.

5. A method as claimed in claim 1, wherein the included angle for the interconnects formed from the first number of solder joints with the reduced amount of solder is in the range 110° to 130°.

6. The method of claim 1, wherein the distance between the component and the substrate is determined and maintained by the second number of solder joints with normal solder content interconnecting the component and the substrate.

7. The method of claim 1, wherein the second number of solder joints with normal solder content retain a barrel shape after solder reflow.

8. The method of claim 1, wherein the first number of solder joints with reduced solder content and the second number of solder joints with normal solder content are partially flattened by a die press prior to connection with the substrate.

9. The method of claim 8, further comprising mechanically upsetting the component during solder reflow.

10. The method of claim 1, wherein the first number of solder joints having a reduced amount of solder are formed from small solder balls having less solder volume than normal solder balls.

11. The method of claim 1, wherein the first number of solder joints having a reduced amount of solder are formed by printing less solder paste on selected substrate pads.

12. The method of claim 11, wherein the printed less solder paste is reflowed together with the second number of normal solder balls.
